(19) United States
(12) Patent Application Publication
(10) Pub. No.: US 2006/0212498 A1
(43) Pub. Date: Sep. 21, 2006

(54) Electric device having calculation anomaly diagnosis function

(75) Inventors: Masayuki Ohashi, Anjo-city (JP); Jirou Hayashi, Ama-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/339,476

(22) Filed: Jan. 26, 2006

(30) Foreign Application Priority Data
Mar. 15, 2005 (JP) 2005-74110

(51) Int. Cl. G06F 15/00

(52) U.S. Cl. 708/200

(57) ABSTRACT

An electric device having calculation anomaly diagnosis function includes: a microcomputer for executing a calculation routine repeatedly by a predetermined times; and a calculation anomaly diagnosis circuit for detecting calculation anomaly of the microcomputer. The microcomputer includes: a central processing unit; a memory; an input/output interface; and a bus. The calculation anomaly diagnosis circuit includes a calculation anomaly reset circuit for resetting the central processing unit into an initial state in a case where the calculation anomaly diagnosis circuit detects the calculation anomaly.

### CROSS REFERENCE TO RELATED APPLICATION

This application is based on Japanese Patent Application No. 2005-74110 filed on Mar. 15, 2005, the disclosure of which is incorporated herein by reference.

### FIELD OF THE INVENTION

The present invention relates to an electric device having calculation anomaly diagnosis function.

### BACKGROUND OF THE INVENTION

An electric power steering (i.e., EPS) device assists driver's steering force by using a torque assist of a motor. The EPS device calculates a target current for energizing the motor in accordance with a driver's steering torque applied to a steering wheel of an automotive vehicle. If a CPU in the EPS device for calculating the target current mistakes the calculation of the target current, the CPU outputs a wrong calculation result. In this case, the torque assist of the motor may exceed or become deficient; and therefore, the steering becomes unstable.

To secure the stable steering even if the CPU fails to calculate the correct target current, a calculation anomaly diagnosis system is provided in, for example, U.S. Pat. No. 6,727,671 and U.S. Pat. No. 6,513,619. The system determines calculation anomaly when the calculation result of the CPU is out of a predetermined range. Then, the system stops the EPS device.

However, in the above method for avoiding the calculation anomaly, when the system determines the calculation anomaly, the EPS device suddenly stops controlling the motor. Therefore, the torque assist of the steering wheel is suddenly disappeared. Thus, it is difficult for the driver of the vehicle to maintain the steering, i.e., the steering feeling of the driver is deteriorated.

Further, even when the calculation result is in the predetermined range, the calculation result may represent a wrong value. In this case, the above system cannot detect the wrong value. Therefore, the steering feeling of the driver is deteriorated.

It is necessary to solve the above problems for not only the EPS control device but also a general in-vehicle microcomputer, since a CPU in the in-vehicle microcomputer may overheat easily.

### SUMMARY OF THE INVENTION

In view of the above-described problem, it is an object of the present invention to provide an electric device having calculation anomaly diagnosis function.

An electric device having calculation anomaly diagnosis function includes: a microcomputer for executing a predetermined calculation routine repeatedly by a predetermined time interval and a predetermined times; and a calculation anomaly diagnosis circuit for detecting calculation anomaly of the microcomputer. The microcomputer includes: a central processing unit including an arithmetic logic unit and a register; a memory including a RAM and a ROM for memorizing a data and a program; an input/output interface; and a bus for transmitting information among the central processing unit, the memory and the input/output interface. The calculation anomaly diagnosis circuit is accommodated in the microcomputer or externally mounted on the microcomputer. The calculation anomaly diagnosis circuit includes a calculation anomaly reset circuit. The calculation anomaly reset circuit resets the central processing unit into an initial state in a case where the calculation anomaly diagnosis circuit detects the calculation anomaly.

In the above device, even when the calculation anomaly is detected by the microcomputer, the calculation routine with the initial state is performed again without outputting the abnormal calculation result to the, external circuit. Thus, the microcomputer starts to perform the calculation routine as soon as possible, when the calculation anomaly is detected. When the microcomputer temporally becomes the calculation anomaly state because of temporally over heat or input of noise, the microcomputer can output the normal calculation result with a tiny time delay such as a time of one cycle of the calculation routine.

Further, in general, the CPU can instruct the reset instruction. Thus, only the calculation anomaly reset circuit for outputting the reset instruction when the calculation anomaly occurs is added to the microcomputer, so that the above function is provided. Thus, circuit layout of the microcomputer is not complicated, so that the manufacturing cost of the microcomputer becomes small.

The calculation anomaly diagnosis circuit and the calculation anomaly reset circuit may be provided by a software, or provided by a digital hardware circuit.

Alternatively, the microcomputer may execute the predetermined calculation routine repeatedly by the predetermined times so that a first calculation subroutine to a Nth calculation subroutine are performed. The Nth time represents the predetermined times. The calculation anomaly diagnosis circuit detects the calculation anomaly on the basis of a calculation result of the Nth calculation subroutine. The calculation anomaly diagnosis circuit outputs the calculation result as an output data when the calculation anomaly diagnosis circuit detects no calculation anomaly. The microcomputer executes again the predetermined calculation routine repeatedly by the predetermined times after the calculation anomaly reset circuit resets the central processing unit when the calculation anomaly diagnosis circuit detects the calculation anomaly.

Alternatively, the calculation anomaly diagnosis circuit detects the calculation anomaly on the basis of a calculation result of a Kth calculation subroutine. The Kth time represents one of the predetermined times. The microcomputer executes again the predetermined calculation routine repeatedly by the predetermined times from the first calculation subroutine after the calculation anomaly reset circuit resets the central processing unit when the calculation anomaly diagnosis circuit detects the calculation anomaly on the Kth calculation subroutine. The calculation anomaly diagnosis circuit executes a next calculation subroutine next to the Kth calculation subroutine when the calculation anomaly diagnosis circuit detects no calculation anomaly. The calculation anomaly diagnosis circuit outputs the calculation result as an output data when the calculation anomaly diagnosis circuit detects no calculation anomaly on the first calculation subroutine to the Nth calculation subroutine. Alternatively, the device may further include a plurality of microcomputers. The calculation anomaly diagnosis circuit and the calculation anomaly reset circuit provide a diagnosis microcomputer for detecting calculation anomaly of each microcomputer. The diagnosis microcomputer is electrically connected to each microcomputer so that the diagnosis microcomputer detects the calculation anomaly in each microcomputer in a predetermined order, and the diagnosis microcomputer resets a microcomputer in a case where the diagnosis microcomputer detects the calculation anomaly of the microcomputer.

Alternatively, the calculation anomaly diagnosis circuit detects the calculation anomaly of the microcomputer on the basis of an input data inputted into the microcomputer and an output data to be outputted from the microcomputer, and the calculation anomaly diagnosis circuit decides that no calculation anomaly occurs in a case where the input data and the output data have a predetermined relationship.

Alternatively, the calculation anomaly diagnosis circuit may stop to operate the microcomputer during a predetermined time in a case where the calculation anomaly occurs on successive predetermined times.

Further, an electric device having calculation anomaly diagnosis function includes: a microcomputer for executing a predetermined calculation routine repeatedly by a predetermined time interval and a predetermined times; and a calculation anomaly diagnosis circuit for detecting calculation anomaly of the microcomputer. The microcomputer includes: a central processing unit including an arithmetic logic unit and a register; a memory including a Ram and a ROM for memorizing a data and a program; an input/output interface; and a bus for transmitting information among the central processing unit, the memory and the input/output interface. The calculation anomaly diagnosis circuit is accommodated in the microcomputer or externally mounted on the microcomputer. The microcomputer executes the predetermined calculation routine repeatedly by the predetermined times so that a first calculation result is obtained. The memory memorizes the first calculation result temporally. The calculation anomaly diagnosis circuit executes an calculation anomaly determination routine before or after the microcomputer executes the predetermined calculation routine repeatedly by the predetermined times. The calculation anomaly determination routine is substantially equal to the predetermined calculation routine, and is performed on the basis of a predetermined input data so that a second calculation result is obtained. The calculation anomaly diagnosis circuit compares the first calculation result to the second calculation result. The calculation anomaly diagnosis circuit decides that the calculation anomaly occurs in a case where the first calculation result is different from the second calculation result. The calculation anomaly diagnosis circuit outputs a calculation anomaly signal when the calculation anomaly occurs.

In the above device, even when the calculation anomaly is detected by the microcomputer, the calculation routine with the initial state is performed again without outputting the abnormal calculation result to the external circuit. Thus, the microcomputer restarts to perform the calculation routine as soon as possible, when the calculation anomaly is detected. When the microcomputer temporally becomes the calculation anomaly state because of temporally over heat or input of noise, the microcomputer can output the normal calculation result with a tiny time delay such as a time of one cycle of the calculation routine.

Further, no additional program for deciding the calculation anomaly is necessitated. Thus, load of the memory is reduced, so that the memory capacity becomes small.

Further, an electric device having calculation anomaly diagnosis function includes: a microcomputer for executing a predetermined calculation routine repeatedly by a predetermined time interval and a predetermined times; and a calculation anomaly diagnosis circuit for detecting calculation anomaly of the microcomputer. The microcomputer includes: a central processing unit including an arithmetic logic unit and a register; a memory including a Ram and a ROM for memorizing a data and a program; an input/output interface; and a bus for transmitting information among the central processing unit, the memory and the input/output interface. The calculation anomaly diagnosis circuit is accommodated in the microcomputer or externally mounted on the microcomputer. The microcomputer executes the predetermined calculation routine on a Kth time so that a first calculation result is obtained. The Kth time represents one of the predetermined times. The memory memorizes the first calculation result temporally. The calculation anomaly diagnosis circuit executes an calculation anomaly determination routine before or after the microcomputer executes the predetermined calculation routine on the Kth time. The calculation anomaly determination routine is substantially equal to the predetermined calculation routine on the Kth time, and is performed on the basis of a predetermined input data so that a second calculation result is obtained. The calculation anomaly diagnosis circuit compares the first calculation result to the second calculation result. The calculation anomaly diagnosis circuit decides that the calculation anomaly occurs on the Kth time in a case where the first calculation result is different from the second calculation result. The calculation anomaly diagnosis circuit outputs a calculation anomaly signal when the calculation anomaly occurs.

In the above device, the microcomputer restarts to perform the calculation routine as soon as possible even when the calculation anomaly is detected. When the microcomputer temporally becomes the calculation anomaly state because of temporally over heat or input of noise, the microcomputer can output the normal calculation result with a tiny time delay such as a time of one cycle of the calculation routine. Further, no additional program for deciding the calculation anomaly is necessitated. Thus, load of the memory is reduced, so that the memory capacity becomes small.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a microcomputer having calculation anomaly diagnosis function according to a first embodiment of the present invention;

FIG. 2 is a flowchart showing an example of a calculation routine in the microcomputer according to the first embodiment;

FIG. 3 is a flowchart showing a calculation routine in the microcomputer according to a second embodiment of the present invention;

FIG. 4 is a block diagram showing a diagnosis circuit attached on the microcomputer according to a third embodiment of the present invention;

FIG. 5 is a block diagram showing a microcomputer control system having multiple microcomputers, according to a fourth embodiment of the present invention;

FIG. 6 is a flowchart showing a calculation anomaly determination routine in the microcomputer according to a fifth embodiment of the present invention;

FIG. 7 is a flowchart showing a calculation anomaly determination routine in the microcomputer according to a sixth embodiment of the present invention;

FIG. 8 is a flowchart showing a calculation anomaly determination routine in the microcomputer according to a seventh embodiment of the present invention; and

FIG. 9 is a flowchart showing a system stop routine in the microcomputer according to an eighth embodiment of the present invention.

### DETAILED DESCRIPTION OF THE PREFERRED EMBODIMENTS

(First Embodiment)

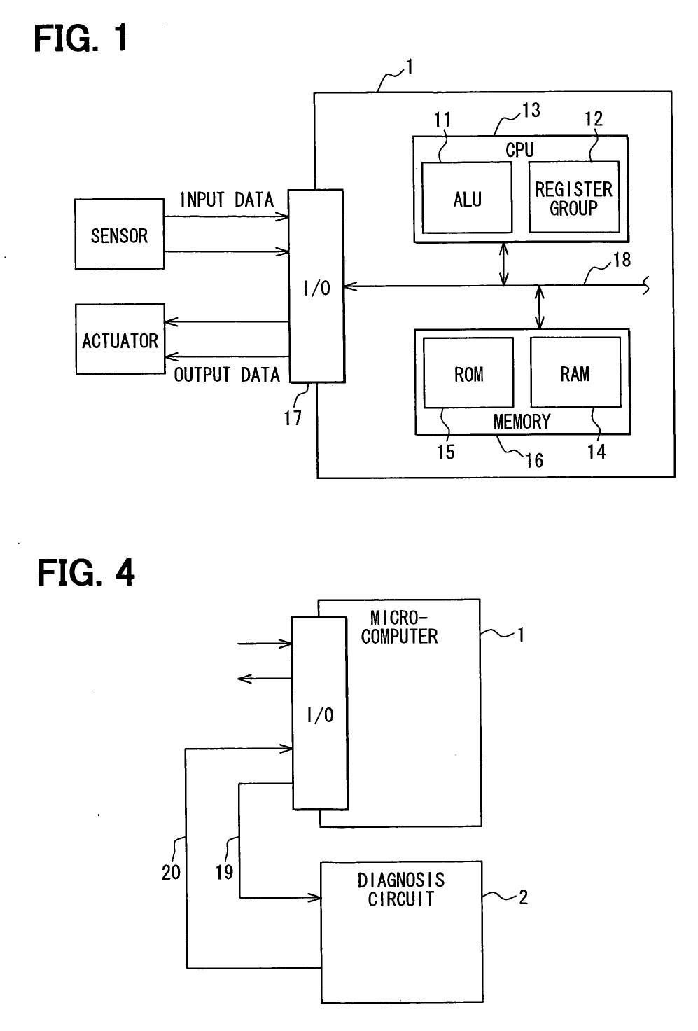

A microcomputer 1 having calculation anomaly diagnosis function according to a first embodiment of the present invention is shown in FIG. 1. The microcomputer 1 includes an arithmetic logic unit (i.e., ALU) 11, a CPU (i.e., central processing unit) 13, a memory 16, an input/output (i.e., I/O) interface 17 and a bus 18. The CPU 13 includes multiple registers as a register group 12. The memory 16 includes a RAM 14 and a ROM 15 for memorizing a data and a program. The bus 18 connects between the memory 16 and the input/output interface 17 so that the bus 18 transmits information between them. The microcomputer 1 is a general eight bit microcomputer. The microcomputer 1 may be other microcomputers.

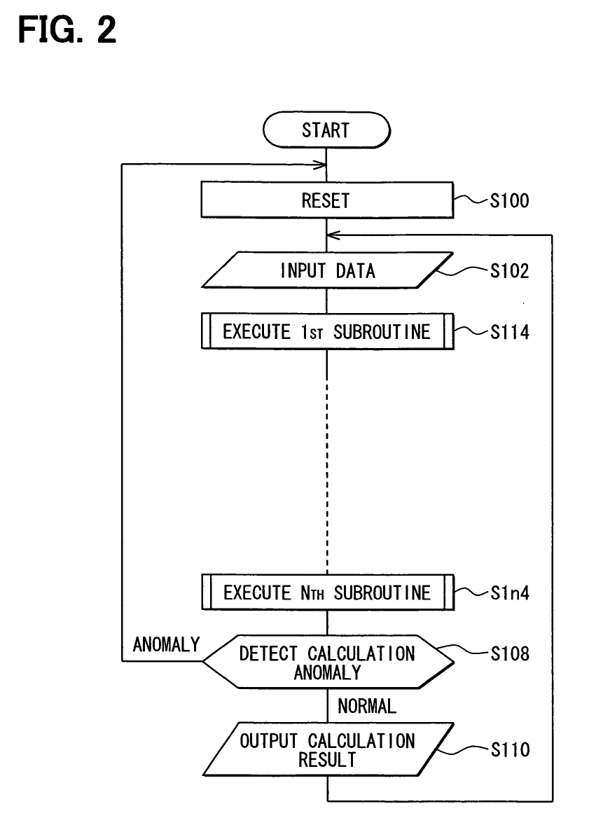

The microcomputer 1 executes a predetermined program so that the microcomputer 1 calculates a calculation result. Specifically, the microcomputer 1 repeatedly executes a calculation of the predetermined program by a predetermined interval on the basis of input data obtained from a sensor. The input data is inputted from the sensor into the microcomputer 1 through the input/output interface 17. The predetermined interval is, for example, 5 milliseconds. The predetermined program is memorized in the ROM 15. The microcomputer 1 periodically outputs the calculation result as an output data to an actuator through the I/O interface 17. An example of a calculation routine in the microcomputer 1 is shown in FIG. 2.

Firstly, a power source switch of the microcomputer 1 is turned on. Then, Step S100 is performed. In Step S100, each part in the microcomputer 1 is reset, i.e., each part is set to be an initial state so that Step S100 provides a reset step. Then, an input data is read, i.e., inputted into the microcomputer 1 in Step S102. In Step S104, the first subroutine as one of subroutines in the calculation routine is performed with using the input data and a calculation result obtained by a previous calculation. These calculations are repeatedly performed by N times from Step S114 to Step S1n4. Finally, in Step S110, a calculation result obtained from the Nth subroutine in Step S1n4 is outputted from the microcomputer 1 to an external circuit (not shown). Then, it returns to Step S102. Accordingly, FIG. 2 represents a simple calculation routine. Although the microcomputer 1 executes the above simple calculation routine, the microcomputer 1 can execute other complicated routine. For example, the microcomputer 1 may execute a routine having steps, which provide to input and/or output a data after each subroutine.

In FIG. 2, a determination step S108 as a diagnosis step for determining calculation anomaly is inserted between the Nth subroutine step S1n4 for executing the Nth subroutine and an output step S110 for outputting the calculation result as an output data. When the microcomputer 1 decides that the calculation result is wrong result, i.e., the calculation anomaly occurs, it goes to the reset step S100.

Specifically, after the Nth subroutine in Step S1n4 is performed as the final subroutine, in Step S108, the microcomputer 1 determines whether the calculation anomaly occurs, i.e., whether the calculation result is correct or incorrect. When the microcomputer 1 decides that the calculation anomaly occurs, it goes to Step S100. When the microcomputer 1 decides that no calculation anomaly occurs, i.e., the calculation is performed normally, it goes to Step S110. Then, the calculation result obtained by the Nth subroutine in Step S1n4 is outputted to the external circuit. Then, it goes to Step S102.

Thus, even if the microcomputer 1 decides that the calculation anomaly occurs, operation of the microcomputer 1 is not stopped, but the microcomputer 1 executes the calculation again after the calculation result is reset. Therefore, in a case where the calculation anomaly occurs accidentally by temporally excess heat or input of surge noise, the microcomputer 1 can calculate the correct calculation result by recalculation. Thus, the microcomputer 1 outputs the correct calculation result, i.e., normal calculation result, so that a problem caused by stoppage of operation of the microcomputer 1 is avoidable. Here, the calculation anomaly determination step S108 is performed by a calculation anomaly determination circuit and a calculation anomaly reset circuit in the microcomputer 1. Specifically, the calculation anomaly determination circuit as the calculation anomaly diagnosis circuit corresponds to the microcomputer 1, Step S108, Step S100 and Step S110. The calculation anomaly reset circuit corresponds to the microcomputer 1, Step S108 and Step S100.

(Second Embodiment)

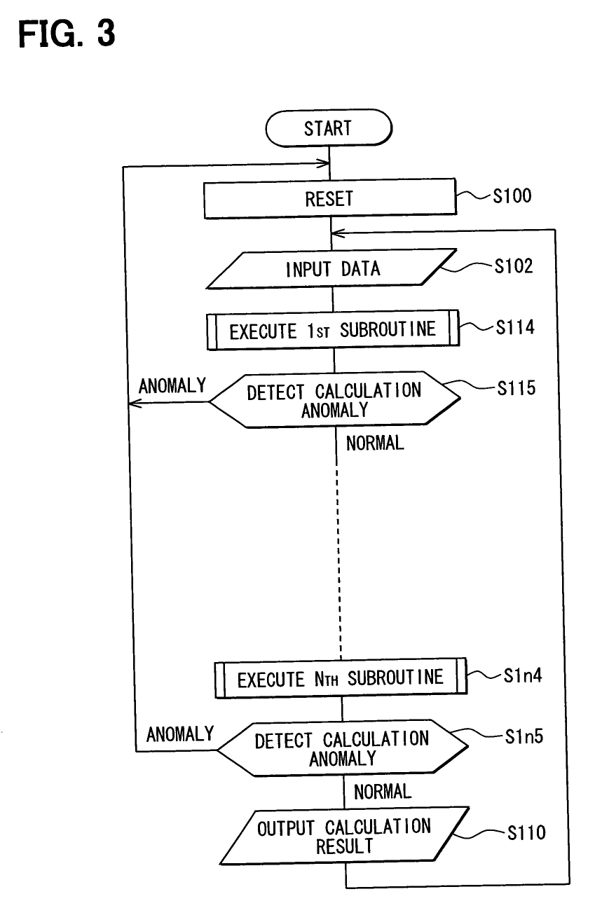

FIG. 3 is a flowchart showing a calculation routine according to a second embodiment of the present invention. In FIG. 3, a calculation anomaly determination step S115-S1n5 is performed after each subroutine S114-S1n4 is finished. When the microcomputer 1 decides that the calculation anomaly occurs in each calculation anomaly determination step S115-S1n5 after the corresponding subroutine S114-S1n4 is finished, it goes to the reset step S100. In this case, if the calculation anomaly occurs at a comparatively early subroutine such as the first subroutine in Step S114, the calculation anomaly can be detected by the microcomputer 1 in the calculation anomaly determination step S115-S1n5 just after the early subroutine is finished. Then, it goes to the reset step S100 just after the microcomputer 1 detects the calculation anomaly. Accordingly, the microcomputer 1 can detect the calculation anomaly early. Thus, time loss caused by the calculation anomaly is reduced, compared with the calculation routine in FIG. 2.

Here, each calculation anomaly determination step S115-S1n5 performs different execution of the calculation anomaly determination, respectively. This is because the microcomputer 1 judges each calculation result obtained from the corresponding subroutine S114-S1n4 just before the calculation anomaly determination step S115-S1n5. Specifically, the microcomputer 1 judges the different calculation result in each calculation anomaly determination step S115-S1n5.

(Third Embodiment)

FIG. 4 shows the microcomputer 1 having a diagnosis circuit 2 according to a third embodiment of the present invention. The diagnosis circuit 2 is externally mounted on the microcomputer 1.

A signal wire 19 connects between an output port of the microcomputer 1 and an input port of the diagnosis circuit 2. Another signal wire 20 connects between an input port of the microcomputer 1 and an output port of the diagnosis circuit 2. The diagnosis circuit 2 provides the calculation anomaly determination circuit and the calculation anomaly reset circuit. Since the calculation load of the diagnosis circuit 2 is small, the diagnosis circuit 2 is formed from a digital circuit. The diagnosis circuit 2 may be formed from a microcomputer.

In this case, the calculation anomaly determination process and the calculation anomaly reset process in Step S108, S1n5 in FIGS. 2 and 3 correspond to a signal transmission process through the signal wire 19 and a signal reception process through the signal wire 20. Specifically, the calculation result is transmitted from the microcomputer 1 to the diagnosis circuit 2 through the signal wire 19 so that the calculation anomaly determination process is performed. Further, a diagnosis result obtained in the diagnosis circuit 2 is inputted from the diagnosis circuit 2 to the microcomputer 1 through the signal wire 20.

Here, when the diagnosis circuit 2 requires to input the input data as an initial data initially inputted into the microcomputer 1, the input data is preliminarily inputted from the microcomputer 1 or the sensor into the diagnosis circuit 2. Specifically, when the input data is necessitated for the calculation anomaly determination process in the diagnosis circuit 2, the input data is inputted into the diagnosis circuit 2 before the diagnosis circuit 2 performs the calculation anomaly determination process. Here, the input data is used for each subroutine S114-S1n4.

In the above device, even if the microcomputer 1 itself is broken down, the calculation anomaly determination routine itself is performed sufficiently. Thus, reliability of the calculation anomaly determination routine is improved.

(Fourth Embodiment)

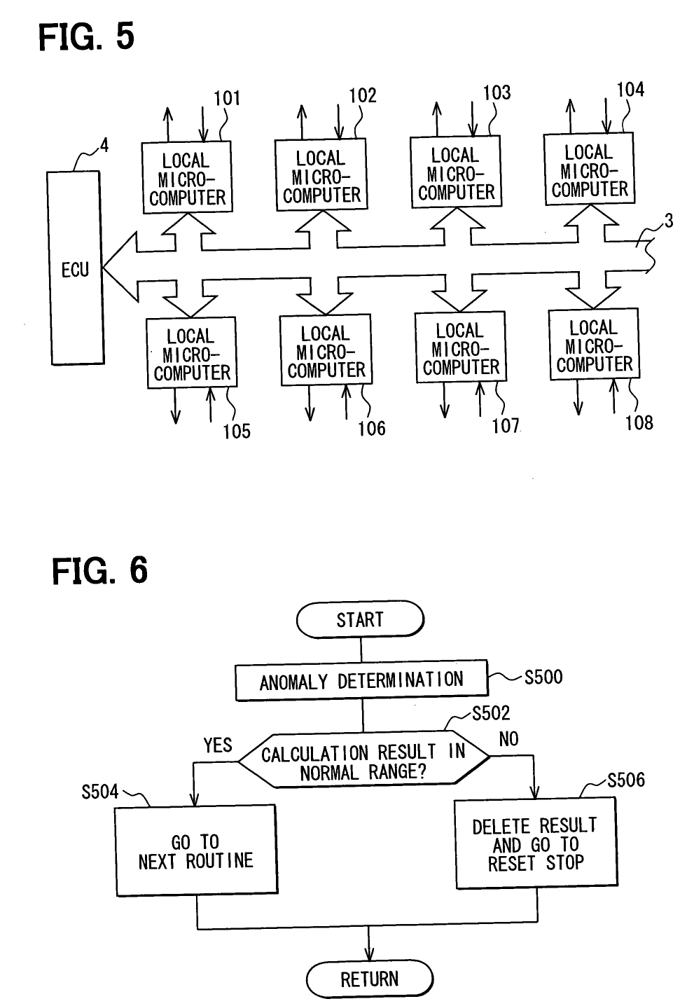

FIG. 5 shows a microcomputer system according to a fourth embodiment of the present invention. The system includes eight local microcomputers 101-108, a main ECU (i.e., electric control unit) 4 and a bus 3. Eight local microcomputers 101-108 are electrically connected through the bus 3 so that a data is transmitted and received among the local microcomputers 101-108 through the bus 3. The main ECU 4 controls eight local microcomputers 101-108 through the bus 3.

Each local microcomputer 101-108 has circuit function equivalent to the microcomputer 1 in FIG. 1. Therefore, the local microcomputer 101-108 independently receives and outputs a signal from a sensor and/or an actuator so that the local microcomputer 101-108 can control the sensor and/or the actuator independently. For example, the local microcomputer 101 is a control device for controlling an EPS device, and the local microcomputer 102 is a control device for controlling a power window. Further, the ECU 4 can receive the sensor signal and output the actuator signal, and control the actuator through the local microcomputers 101-108.

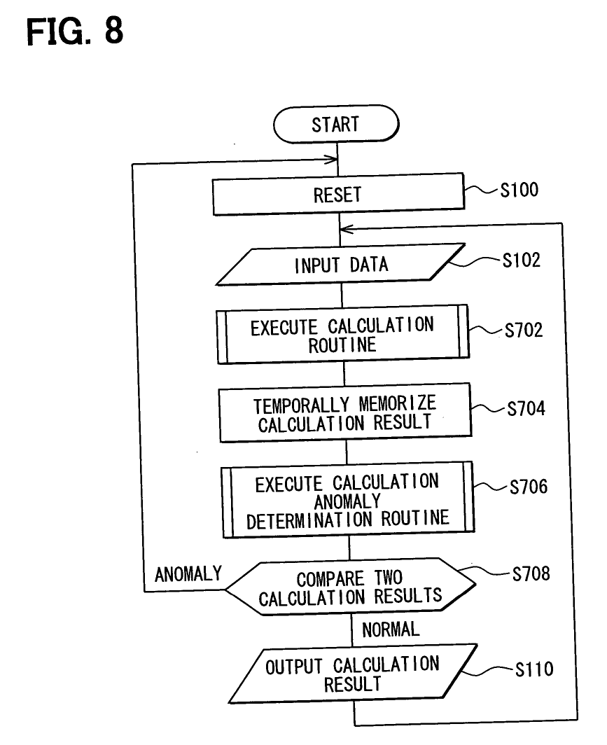

The main ECU 4 provides the diagnosis circuit 2 shown in FIG. 4. Specifically, the main ECU 4 provides the diagnosis circuit of all local microcomputers 101-108. For example, each local microcomputer 101-108 outputs the calculation result to the main ECU 4 after a calculation routine in the local microcomputer 101-108 is finished, for example, shown in FIG. 8. The main ECU 4 judges whether the calculation anomaly occurs. When the calculation anomaly occurs, the ECU 4 instructs the local microcomputer 101-108 to reset the calculation anomaly. When no calculation anomaly occurs, the ECU 4 instructs the local microcomputer 101-108 to execute the next calculation. On the basis of the instruction from the ECU 4, the local microcomputer 101-108 executes the next operation. Thus, the conventional ECU 4 for controlling the local microcomputers 101-108 can perform the calculation anomaly determination process of each local microcomputer 101-108. Even if the calculation anomaly occurs at a local microcomputer 101-108, the ECU 4 can diagnose the calculation anomaly easily and precisely. Thus, correction of the calculation anomaly is easily and rapidly performed.

In the above system, multiple microcomputers can be tested by one diagnosis microcomputer. Thus, the circuit layout of the system is simplified. For example, general in-vehicle equipment includes multiple local microcomputers for controlling many parts and a main computer for outputting instructions to the local microcomputers. In this case, the diagnosis microcomputer is only mounted on the main computer. Thus, the circuit layout of the main computer and the local microcomputers is improved.

(Fifth Embodiment)

FIG. 6 is a flowchart showing a calculation anomaly determination routine according to a fifth embodiment of the present invention. The flowchart is an example of the calculation anomaly determination step S108 shown in FIG. 2. In this case, a normal calculation result range of an output data as a normal value is preliminarily memorized in the microcomputer 1. In the calculation anomaly determination step S500, it goes to Step S502. In Step S502, the microcomputer 1 decides whether the calculation result obtained by the Nth subroutine in Step S1n4 is in the normal calculation result range. When the calculation result is in the normal calculation result range, i.e., when the calculation result is a normal value, it goes to Step S504. In Step S504, the microcomputer 1 instructs to go to the next calculation routine. When the result is not in the normal calculation result range, i.e., when the result is an abnormal value, it goes to Step S506. In Step S506, the microcomputer 1 instructs to delete the calculation result and to return to the reset step S100. Thus, the calculation anomaly can be detected easily.

The above calculation anomaly determination step S500 is a constant range comparison method. The determination step S500 can be applied to each calculation anomaly determination step S115-S1n5 in FIG. 3. In this case, the normal calculation result range of the calculation result in each subroutine S114-S1n4 in FIG. 3 is respectively memorized in the microcomputer 1 so that the calculation result in each subroutine is respectively compared with the corresponding normal calculation result range.

Here, if the output data is obviously incorrect result, the microcomputer 1 can decide the calculation anomaly without referring to the input data.

(Sixth Embodiment)

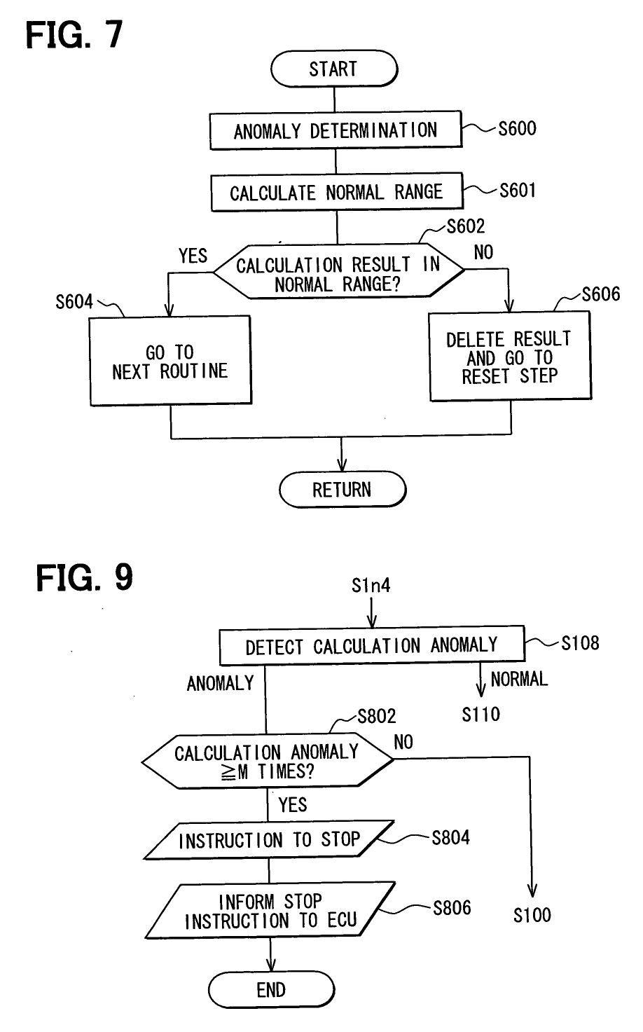

FIG. 7 is a flowchart showing a calculation anomaly determination routine according to a sixth embodiment of the present invention. The flowchart is an example of the calculation anomaly determination step S108 shown in FIG. 2. In this case, the input data initially inputted into the microcomputer 1 in Step S102 in FIG. 2 together with the calculation result is utilized for the calculation anomaly determination process.

In the calculation anomaly determination step S600, it goes to Step S601. In Step S601, the microcomputer 1 calculates the normal calculation result range on the basis of the input data. Specifically, the normal calculation result range is obtained by using a data map and the input data. The data map is preliminarily memorized in the microcomputer 1. Alternatively, the data map may be provided by a hardware circuit.

In Step S602, the microcomputer 1 decides whether the calculation result obtained by the Nth subroutine in Step S1n4 is in the normal calculation result range calculated in Step S601. When the calculation result is in the normal calculation result range, i.e., when the normal calculation is performed, it goes to Step S604. In Step S604, the microcomputer 1 instructs to go to the next calculation routine. When the calculation result is not in the normal calculation result range, i.e., when the calculation anomaly occurs, it goes to Step S606. In Step S606, the microcomputer 1 instructs to delete the calculation result and to return to the reset step S100. Thus, the calculation anomaly can be detected easily. Here, in the reset step S100, a register for holding the calculation result is reset to zero. Accordingly, deletion of the calculation result may be skipped, i.e., eliminated.

(Seventh Embodiment)

FIG. 8 is a flowchart showing a calculation routine according to a seventh embodiment of the present invention. The flowchart shows one example of a calculation routine in the microcomputer 1. The routine includes a calculation anomaly determination routine, which is different from the constant range comparison method of the routine shown in FIGS. 6 and 7.

In Step S100, each part in the microcomputer 1 is reset so that Step S100 provides the reset step. Then, the input data is read, i.e., inputted into the microcomputer 1 in Step S102. In Step S702, the first to the Nth subroutines are performed with using the input data and a calculation result obtained by a previous calculation so that Step S702 corresponds to Steps S114 to S1n4. In Step S704, the calculation result obtained in Step S702 is temporally memorized in a predetermined register. Next, in Step S706, a calculation routine, which is the same as the calculation routine in Step S702, is executed as a calculation anomaly determination routine by using a predetermined value as the input data. Next, the calculation result obtained by the calculation anomaly determination routine in Step S706 is compared with the calculation result temporally memorized in Step S704. When the calculation result in Step S706 is completely different from the calculation result in Step S704, the microcomputer 1 determines that the calculation result may not be correct because of overheat of the CPU or failure of the CPU. Then, after a predetermined time has passed, it goes to Step S100. When the calculation result in Step S706 is substantially equal to the calculation result in Step S704, the microcomputer 1 determines that the calculation result is correct, i.e., the CPU operates normally. Then, in Step S110, the microcomputer 1 outputs the calculation result obtained in Step S702 as the output data to the external circuit such as the actuator.

In the above device, no additional program for deciding the calculation anomaly is necessitated. Thus, load of the memory is reduced, so that the memory capacity becomes small. Here, the case where the calculation result in Step S706 is completely different from the calculation result in Step S704, it is considered that the calculation anomaly of the calculation routine, the calculation anomaly of the calculation anomaly determination routine or error of the determination process for comparing two calculation results occurs. However, these anomalies or the error can be eliminated by the reset routine in S100. Thus, the calculation is performed again without time delay.

Although the calculation anomaly determination routine in Step S706 is performed after the first to Nth subroutines are completed, similar to the routine in FIG. 3, a calculation anomaly determination routine may be performed after each subroutine S114-S1n4 is performed. Here, each calculation anomaly determination routine is the same as the corresponding subroutine S114-S1n4. When the microcomputer 1 decides that the calculation anomaly occurs after each subroutine S114-S1n4 is finished, it goes to the reset step S100. Here, each calculation anomaly determination routine performs different execution of the calculation anomaly determination process, respectively.

Although the calculation anomaly determination routine is performed after the Nth calculation routine is ended, a circuit anomaly determination routine may be performed to test the CPU 13 or the ALU 11.

(Eighth Embodiment)

FIG. 9 is a flowchart showing a permanent failure determination routine of the microcomputer 1 according to an eighth embodiment of the present invention. The routine checks continuation of the calculation anomaly in the microcomputer 1. Thus, this routine corresponds to a permanent fault detection process. When the microcomputer 1 or the CPU 13 permanently breaks down, it is required to stop the microcomputer 1 or the CPU 13. Accordingly, the routine is a system stop routine in case of permanent failure of the microcomputer 1 or the CPU 13.

In Step S802, the microcomputer 1 decides whether the number of times of the calculation anomaly is equal to or larger than predetermined times, i.e., M times. Specifically, when the calculation anomaly occurs on successive M times, it goes to Steps S804. When the number of times of the calculation anomaly is smaller than the M times, it goes to Step S100.

In Step S804, the microcomputer 1 decides that the permanent failure of the microcomputer 1 or the CPU occurs; and then, the microcomputer 1 instructs to stop the operation of the microcomputer 1 itself. This instruction to stop of operation may be inputted into the microcomputer 1 itself. Further, the instruction to stop may be inputted into the main ECU 4 so that the main ECU 4 controls to stop the microcomputer 1. When the main ECU 4 receives the stop signal, the ECU 4 executes to stop the operation of the microcomputer 1, and further, executes other processes. Here, the stop instruction of the microcomputer 1 can be automatically or manually cancelled after a predetermined time has passed. When the stop instruction is cancelled manually, a predetermined condition is required for allowance of cancellation of the stop instruction.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An electric device having calculation anomaly diagnosis function, comprising:
a microcomputer for executing a predetermined calculation routine repeatedly by a predetermined time interval and a predetermined times; and
a calculation anomaly diagnosis circuit for detecting calculation anomaly of the microcomputer, wherein
the microcomputer includes:
a central processing unit including an arithmetic logic unit and a register;
a memory including a RAM and a ROM for memorizing a data and a program;
an input/output interface; and
a bus for transmitting information among the central processing unit, the memory and the input/output interface,
the calculation anomaly diagnosis circuit is accommodated in the microcomputer or externally mounted on the microcomputer,
the calculation anomaly diagnosis circuit includes a calculation anomaly reset circuit, and
the calculation anomaly reset circuit resets the central processing unit into an initial state in a case where the calculation anomaly diagnosis circuit detects the calculation anomaly.

2. The device according to claim 1, wherein
the microcomputer executes the predetermined calculation routine repeatedly by the predetermined times so that a first calculation subroutine to a Nth calculation subroutine are performed,
the Nth time represents the predetermined times,
the calculation anomaly diagnosis circuit detects the calculation anomaly on the basis of a calculation result of the Nth calculation subroutine,
the calculation anomaly diagnosis circuit outputs the calculation result as an output data when the calculation anomaly diagnosis circuit detects no calculation anomaly, and
the microcomputer executes again the predetermined calculation routine repeatedly by the predetermined times after the calculation anomaly reset circuit resets the central processing unit when the calculation anomaly diagnosis circuit detects the calculation anomaly.

3. The device according to claim 1, wherein
the microcomputer executes the predetermined calculation routine repeatedly by the predetermined times so that a first calculation subroutine to a Nth calculation subroutine are performed,
the Nth time represents the predetermined times,
the calculation anomaly diagnosis circuit detects the calculation anomaly on the basis of a calculation result of a Kth calculation subroutine,
the Kth time represents one of the predetermined times,
the microcomputer executes again the predetermined calculation routine repeatedly by the predetermined times from the first calculation subroutine after the calculation anomaly reset circuit resets the central processing unit when the calculation anomaly diagnosis circuit detects the calculation anomaly on the Kth calculation subroutine,
the calculation anomaly diagnosis circuit executes a next calculation subroutine next to the Kth calculation subroutine when the calculation anomaly diagnosis circuit detects no calculation anomaly, and
the calculation anomaly diagnosis circuit outputs the calculation result as an output data when the calculation anomaly diagnosis circuit detects no calculation anomaly on the first calculation subroutine to the Nth calculation subroutine.

4. The device according to claim 1, wherein
the calculation anomaly diagnosis circuit and the calculation anomaly reset circuit are externally mounted on the microcomputer.

5. The device according to claim 4, further comprising:
a plurality of microcomputers, wherein
each microcomputer executes a predetermined calculation routine repeatedly by a predetermined time interval,
each microcomputer includes:
a central processing unit including an arithmetic logic unit and a register;
a memory including a RAM and a ROM for memorizing a data and a program;
an input/output interface; and
a bus for transmitting information among the central processing unit, the memory and the input/output interface,
the calculation anomaly diagnosis circuit and the calculation anomaly reset circuit provide a diagnosis microcomputer for detecting calculation anomaly of each microcomputer,
the diagnosis microcomputer is electrically connected to each microcomputer so that the diagnosis microcomputer detects the calculation anomaly in each microcomputer in a predetermined order, and
the diagnosis microcomputer resets a microcomputer in a case where the diagnosis microcomputer detects the calculation anomaly of the microcomputer.

6. The device according to claim 1, wherein
the calculation anomaly diagnosis circuit detects the calculation anomaly of the microcomputer on the basis of an input data inputted into the microcomputer and an output data to be outputted from the microcomputer, and
the calculation anomaly diagnosis circuit decides that no calculation anomaly occurs in a case where the input data and the output data have a predetermined relationship.

7. The device according to claim 6, wherein
the input data is initially inputted into the microcomputer,
the output data is a calculation result of the predetermined calculation routine,
the microcomputer preliminarily memorizes a normal calculation range,
the calculation anomaly diagnosis circuit decides that no calculation anomaly occurs when the calculation result is in the normal calculation range, and
the calculation anomaly diagnosis circuit decides that the calculation anomaly occurs when the calculation result is not in the normal calculation range.

8. The device according to claim 6, wherein
the input data is initially inputted into the microcomputer,
the output data is a calculation result of the predetermined calculation routine,
the microcomputer calculates a normal calculation range on the basis of the input data by using a range map, which is preliminarily memorized in the microcomputer,
the calculation anomaly diagnosis circuit decides that no calculation anomaly occurs when the calculation result is in the normal calculation range, and
the calculation anomaly diagnosis circuit decides that the calculation anomaly occurs when the calculation result is not in the normal calculation range.

9. The device according to claim 1, wherein
the microcomputer executes the predetermined calculation routine repeatedly by the predetermined times so that a first calculation result is obtained,
the memory memorizes the first calculation result temporally,
the calculation anomaly diagnosis circuit executes an calculation anomaly determination routine before or after the microcomputer executes the predetermined calculation routine repeatedly by the predetermined times,
the calculation anomaly determination routine is substantially equal to the predetermined calculation routine, and is performed on the basis of a predetermined input data so that a second calculation result is obtained,
the calculation anomaly diagnosis circuit compares the first calculation result to the second calculation result,
the calculation anomaly diagnosis circuit decides that the calculation anomaly occurs in a case where the first calculation result is different from the second calculation result, and
the calculation anomaly diagnosis circuit outputs a calculation anomaly signal when the calculation anomaly occurs.

10. The device according to claim 1, wherein
the microcomputer executes the predetermined calculation routine on a Kth time so that a first calculation result is obtained,
the Kth time represents one of the predetermined times,
the memory memorizes the first calculation result temporally,
the calculation anomaly diagnosis circuit executes an calculation anomaly determination routine before or after the microcomputer executes the predetermined calculation routine on the Kth time,
the calculation anomaly determination routine is substantially equal to the predetermined calculation routine on the Kth time, and is performed on the basis of a predetermined input data so that a second calculation result is obtained,
the calculation anomaly diagnosis circuit compares the first calculation result to the second calculation result,
the calculation anomaly diagnosis circuit decides that the calculation anomaly occurs on the Kth time in a case where the first calculation result is different from the second calculation result, and
the calculation anomaly diagnosis circuit outputs a calculation anomaly signal when the calculation anomaly occurs on the Kth time.

11. The device according to claim 1, wherein
the calculation anomaly diagnosis circuit stops to operate the microcomputer during a predetermined time in a case where the calculation anomaly occurs on successive predetermined times.

12. An electric device having calculation anomaly diagnosis function, comprising:
a microcomputer for executing a predetermined calculation routine repeatedly by a predetermined time interval and a predetermined times; and
a calculation anomaly diagnosis circuit for detecting calculation anomaly of the microcomputer, wherein
the microcomputer includes:
a central processing unit including an arithmetic logic unit and a register;
a memory including a RAM and a ROM for memorizing a data and a program;
an input/output interface; and
a bus for transmitting information among the central processing unit, the memory and the input/output interface,
the calculation anomaly diagnosis circuit is accommodated in the microcomputer or externally mounted on the microcomputer,
the microcomputer executes the predetermined calculation routine repeatedly by the predetermined times so that a first calculation result is obtained,
the memory memorizes the first calculation result temporally,
the calculation anomaly diagnosis circuit executes an calculation anomaly determination routine before or after the microcomputer executes the predetermined calculation routine repeatedly by the predetermined times,
the calculation anomaly determination routine is substantially equal to the predetermined calculation routine, and is performed on the basis of a predetermined input data so that a second calculation result is obtained,
the calculation anomaly diagnosis circuit compares the first calculation result to the second calculation result,
the calculation anomaly diagnosis circuit decides that the calculation anomaly occurs in a case where the first calculation result is different from the second calculation result, and
the calculation anomaly diagnosis circuit outputs a calculation anomaly signal when the calculation anomaly occurs.

13. An electric device having calculation anomaly diagnosis function, comprising:
a microcomputer for executing a predetermined calculation routine repeatedly by a predetermined time interval and a predetermined times; and
a calculation anomaly diagnosis circuit for detecting calculation anomaly of the microcomputer, wherein
the microcomputer includes:
a central processing unit including an arithmetic logic unit and a register;
a memory including a RAM and a ROM for memorizing a data and a program;
an input/output interface; and
a bus for transmitting information among the central processing unit, the memory and the input/output interface,
the calculation anomaly diagnosis circuit is accommodated in the microcomputer or externally mounted on the microcomputer,
the microcomputer executes the predetermined calculation routine on a Kth time so that a first calculation result is obtained,
the Kth time represents one of the predetermined times,
the memory memorizes the first calculation result temporally,
the calculation anomaly diagnosis circuit executes an calculation anomaly determination routine before or after the microcomputer executes the predetermined calculation routine on the Kth time,
the calculation anomaly determination routine is substantially equal to the predetermined calculation routine on the Kth time, and is performed on the basis of a predetermined input data so that a second calculation result is obtained,
the calculation anomaly diagnosis circuit compares the first calculation result to the second calculation result,
the calculation anomaly diagnosis circuit decides that the calculation anomaly occurs on the Kth time in a case where the first calculation result is different from the second calculation result, and
the calculation anomaly diagnosis circuit outputs a calculation anomaly signal when the calculation anomaly occurs.
